(19) United States
(12) Patent Application Publication
(10) Pub. No.: US 2006/0007785 A1
(43) Pub. Date: Jan. 12, 2006

(54) Method and system for displaying appointments

(76) Inventors: Juan C. Fernandez, Boca Raton, FL (US); Jose E. Korneluk, Boynton Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/887,180

(22) Filed: Jul. 8, 2004

(51) Int. Cl. G04B 47/00; G04B 45/00

(52) U.S. Cl. 368/10; 368/43; 368/250

(57) ABSTRACT

The invention concerns a method (200) and system (100) for displaying appointments. The method includes the steps of—in an electronic device (110)—displaying (212) an analog clock face (300) that is divisible into a plurality of time regions (318) in which the plurality of time regions includes at least a portion of an ante meridiem section (320) and a post meridiem section (322), associating (216) a time region with an appointment and marking (222) the time region, including at least a portion of one of the ante meridiem section and the post meridiem section, to indicate visually that the appointment is associated with the time region. The method can further include the step of assigning (220) an icon (324) to the marked time region to indicate the type of appointment associated with the time region.

### BACKGROUND OF THE INVENTION

1. Field of the Invention

This invention relates in general to methods and systems for mobile communication devices in vehicles and more particularly, for alerting users of such devices.

2. Description of the Related Art

In recent years, electronic devices, such as cellular telephones and personal digital assistants, have become commonplace. Many of these electronic devices incorporate graphical user interfaces (GUIs) and can perform a variety of tasks and can execute numerous applications. Some of the applications enable users of these devices to manage scheduling and other related tasks. The application programs, for example, can include calendar and scheduling programs, which can permit a user to enter appointments into the electronic device for a later reminder. Most electronic devices include real-time clocks that provide time and date information. The real-time clocks are useful for providing current date and time information to these calendar and scheduling programs.

Checking for appointments that have been entered into electronic devices having such programs, however, can be tedious. For example, a user typically has to scroll through user interface menus and submenus and multiple screen displays every time they need to view his or her appointments and task deadlines in the calendar. A person endeavoring to complete work before a deadline often repeatedly has to access the user interface menus and submenus to keep track of tasks and appointments. Unfortunately, this process consumes precious time during time-critical events, as well as imposes significant inconvenience to users.

### SUMMARY OF THE INVENTION

The present invention concerns a method for displaying appointments. The method includes the steps of—in an electronic device—displaying an analog clock face that is divisible into a plurality of time regions in which the plurality of time regions includes at least a portion of an ante meridiem section and a post meridiem section, associating a time region with an appointment, and marking the time region, including at least the portion of the ante meridiem section or the post meridiem section, to indicate visually that the appointment is associated with the time region. The method can also include the step of assigning an icon to the time region to indicate the type of appointment associated with the time region.

In one arrangement, the marking the time region step can include the steps of bounding the time region with at least a first segment and a second segment in which the first segment borders the temporal beginning of the time region and the second segment borders the temporal end of the time region and shading at least a portion of the time region between the first segment and the second segment. The shaded portion of the time region can include the portion of at least one of the ante meridiem section and the post meridiem section. The first segment, the second segment and the shaded portion can all be comprised of the same color.

In another arrangement, the method can further include the steps of associating a subsequent time region with a subsequent appointment and marking the subsequent time region, including the portion of the ante meridiem section or the post meridiem section, to indicate visually that the subsequent appointment is associated with the subsequent time region. As an example, the first segment, the second segment and the shaded portion of the subsequent time region can all be comprised of a color that is different from the color of the first segment, the second segment and the shaded portion of any other time regions.

As another example, the time regions can be minute regions or hour regions. The method can also include the step of demarking the time region once the time region expires. The method can further include the steps of entering information associated with the appointment into the electronic device and selecting the time region that is associated with the appointment to access information associated with the appointment.

In yet another embodiment, the analog clock face can have a series of numbers that are positioned along an edge of the analog clock face. In addition, the method can include the step of shifting towards the numbers the ante meridiem section or the post meridiem section based on the current time. The method can also include the steps of assigning a description to the time region, determining whether the time region is an upcoming time region, and displaying the description of the time region if the time region is an upcoming region.

The present invention also concerns a system for displaying appointments. The electronic device includes a user interface section and a processor coupled to the user interface section. The user interface section has at least a display for displaying an analog clock face that is divisible into a plurality of time regions. The plurality of time regions includes at least a portion of an ante meridiem section and a post meridiem section. The processor can be programmed to associate a time region with an appointment and to mark the time region, including at least the portion of the ante meridiem section or the post meridiem section, to indicate visually that the appointment is associated with the time region. The system can also include suitable software and/or circuitry to carry out the processes described above.

The present invention also concerns a machine readable storage having stored thereon a computer program having a plurality of code sections executable by a computing device. The code sections cause the computing device to perform the steps of displaying an analog clock face that is divisible into a plurality of time regions in which the plurality of time regions includes at least a portion of an ante meridiem section and a post meridiem section, associating a time region with an appointment and marking the time region, including at least the portion of the ante meridiem section or the post meridiem section, to indicate visually that the appointment is associated with the time region.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for displaying appointments in accordance with an embodiment of the inventive arrangements;

FIG. 2 illustrates a portion of a method for displaying appointments in accordance with an embodiment of the inventive arrangements;

FIG. 3 illustrates another portion of the method of FIG. 2 for displaying appointments in accordance with an embodiment of the inventive arrangements; and

FIG. 4 illustrates an example of an analog clock face in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for displaying appointments. In one arrangement, an analog clock face can be displayed on a display of an electronic device. This analog clock face can be divisible into a plurality of time regions, which can include an ante meridiem (AM) section and a post meridiem (PM) section. An appointment can be associated with a time region, and the time region can be marked or hi-lighted to indicate visually that the appointment is associated with the time region. To help a user distinguish between AM and PM time regions, the appropriate AM section or PM section can be marked or hi-lighted, too.

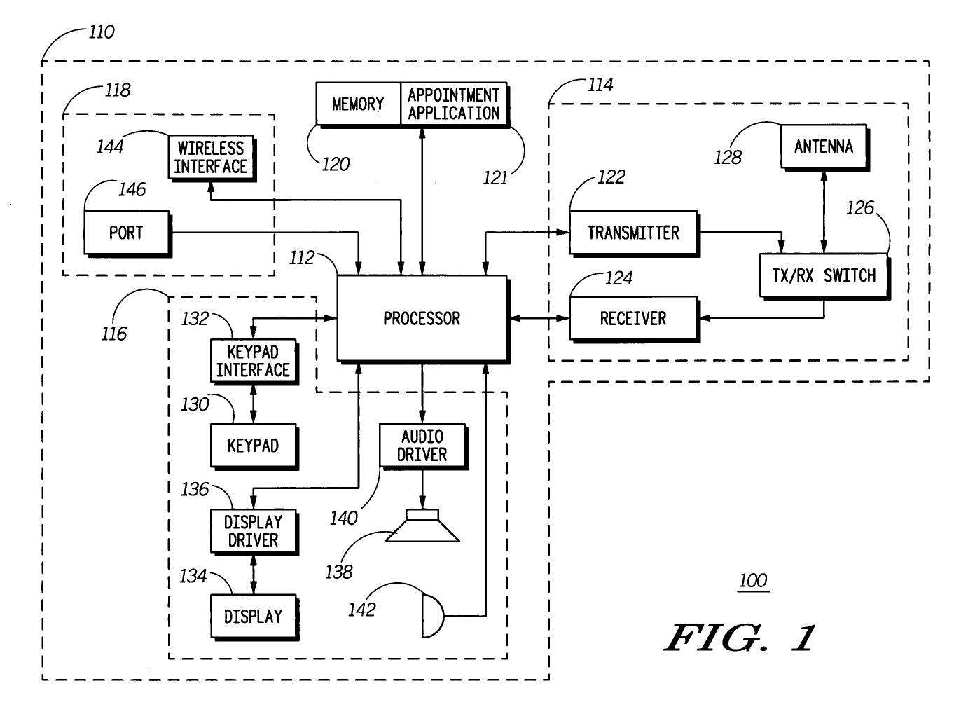

Referring to FIG. 1, a system 100 for displaying appointments is shown. The system 100 can be part of an electronic device 110, which can also be referred to as a computing device. Although examples will be presented in which the electronic device 110 is a mobile telecommunications unit (such as a cellular telephone, two way radio or personal digital assistant), it is understood that the invention is not so limited. Other devices can serve as the electronic device 110, including—but not limited to—desktop computers and laptop computers.

In one arrangement, the system 100 can include a processor 112, a transceiver section 114, a user interface section 116, a synchronization section 118 and a memory block 120. The processor 112 can be loaded with a plurality of code sections that cause the processor 112 to perform steps in accordance with the inventive arrangements, which will be explained below.

The transceiver section 114 can include a transmitter 122, a receiver 124, a transmitter/receiver (TX/RX) switch 126 and an antenna 128. The transmitter 122 and the receiver 124 can be coupled to both the processor 112 and the TX/RX switch 126. The TX/RX switch 126 can also be coupled to the antenna 128. As is known in the art, the transmitter 122, the receiver 124, the TX/RX switch 126 and the antenna 128 can permit the electronic device 110 to transmit and receive wireless communications signals. It is understood, however, that the transceiver section 114 is optional, and it is not required to practice the inventive arrangements.

In one embodiment, the user interface section 116 can include a keypad 130, a keypad interface 132, a display 134, a display driver 136, a speaker 138, an audio driver 140 and a microphone 142. The user interface section 116 can include other suitable peripherals, too. The keypad interface 132, the display driver 136, the audio driver 140 and the microphone 142 can all be coupled to the processor 112. The keypad 130 can be used to enter information into the electronic device 110. Specifically, the keypad interface 132 can receive input from the keypad 130 and can transfer this input information to the processor 112 for further processing.

The display 134 can be used to display any suitable type of data, which can be received from the display driver 136. In one arrangement and as is known in the art, the display 134 can be designed to permit a user to input information into the electronic device 110, such as where the display 134 is a touch screen display. This input information can be transferred to the processor 112 through the display driver 136. Audio can be broadcast from the electronic device 110 through the audio driver 140 and the speaker 138 and can be received at the microphone 142.

As is known in the art, the memory block 120 can store instructions that the processor 112 executes for operation. In one arrangement, the memory block 120 can store an appointment application 121. In addition, the synchronizing section 118 can include a wireless interface 144 and a port 146, both of which can be coupled to the processor 112. As an example, the wireless interface 144 can include suitable software and circuitry for enabling the electronic device 110 to wirelessly communicate with other electronic devices through any suitable low power, short distance wireless communications interface solution. Examples include Bluetooth and Wireless Fidelity. The port 146 can receive any suitable connector to permit the electronic device 110 to communicate with another electronic device. In either arrangement, data can be transferred between the electronic device 110 and another unit. This feature can permit applications stored in the electronic device 110, such as the appointment application 121, to be synchronized from external sources or applications.

In operation, a user can enter information into the electronic device 110 through the user interface section 116. For example, the user can enter information through the keypad 132, the display 134 or even the microphone 142, if the electronic device 110 contains suitable voice recognition software and circuitry. As another example, the user can input the information from another electronic device through the synchronization section 118. In one arrangement, the input information can concern a scheduled appointment or some other important reminder. Once it receives the input information, the processor 112 can update or synchronize the appointment application 121 stored in the memory block 120.

Additionally, the processor 112, through the display driver 136, can cause an analog clock face (not shown in FIG. 1) to be displayed on the display 134. In accordance with the inventive arrangements, the time at which these appointments are to occur can be displayed on the analog clock face. In one particular arrangement, the analog clock face can be designed to indicate whether the appointment occurs in the AM or PM, as will be explained below. It must be noted that the invention is not limited to the system 100 shown in FIG. 1, as the invention can be practiced in other suitable systems or devices.

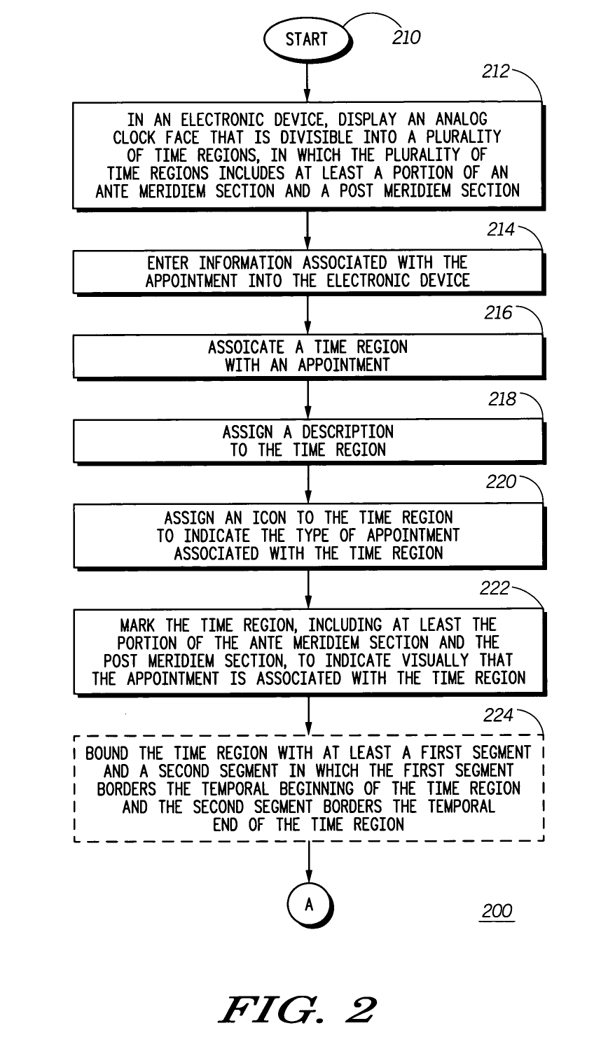

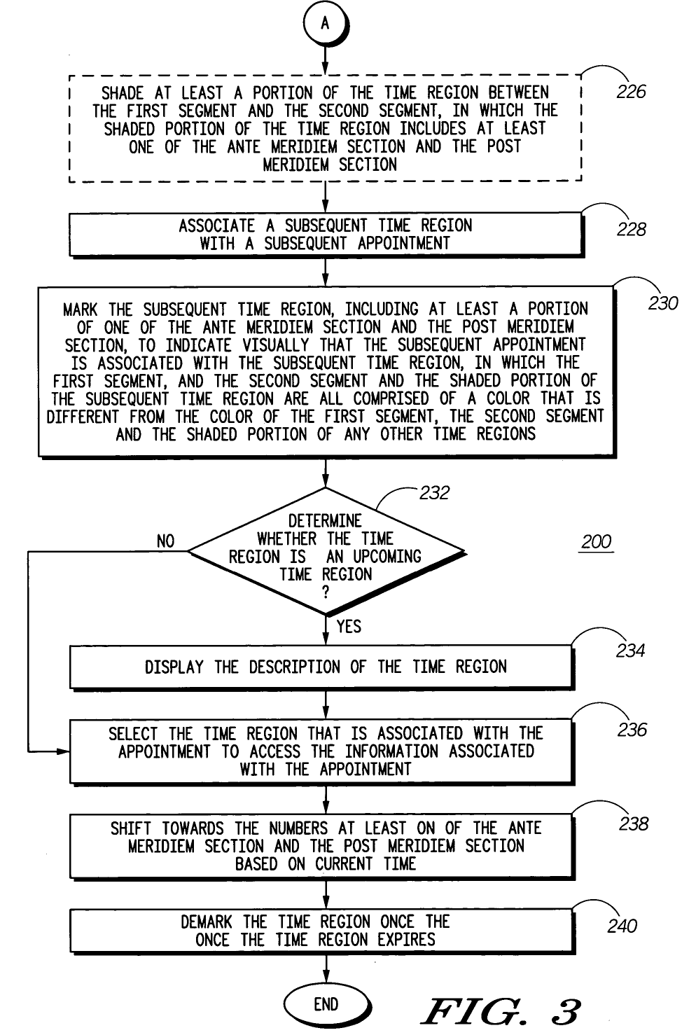

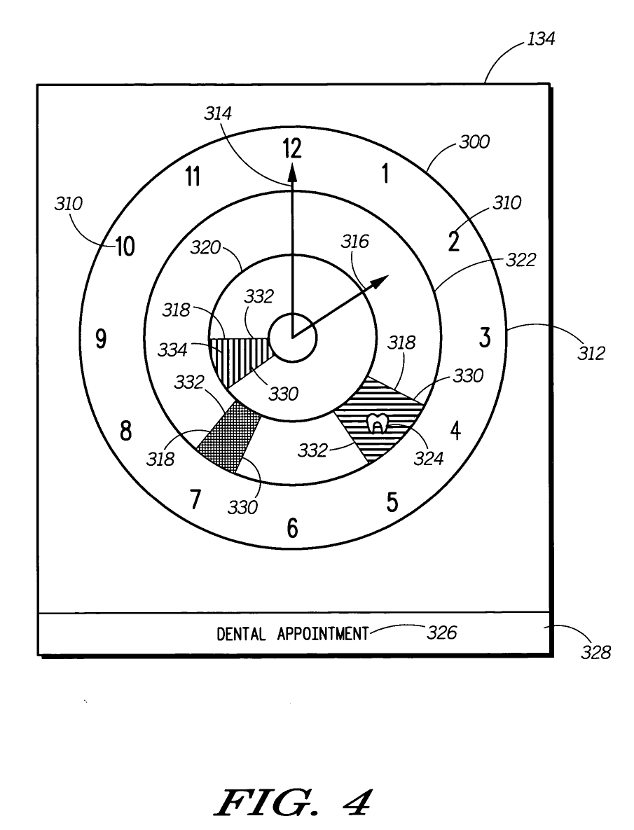

Referring to FIGS. 2 and 3, a method 200 for displaying appointments is shown. In addition, referring to FIG. 4, an example of an analog clock face 300 being displayed on the display 134 is illustrated. In describing the method 200, reference will be made to FIGS. 1 and 4, although the method 200 can be practiced in other suitable systems, and the invention is not limited to the particular analog clock face design shown in FIG. 4. Moreover, the method 200 is not limited to the particular order in which the steps are shown in FIGS. 2 or 3, and the inventive method can be practiced with additional steps or by skipping any of the steps that are shown.

At step 210, the method 200 can begin. At step 212, in an electronic device, an analog clock face that is divisible into a plurality of time regions can be displayed. The plurality of time regions can include at least a portion of an ante meridiem (AM) section and a post meridiem (PM) section. At step 214, information associated with one or more appointments can be entered into the electronic device. One or more of the time regions can be associated with the appointment(s), as shown at step 216. At step 218, a description can be assigned to the time region, and an icon can be assigned to the time region to indicate the type of appointment associated with the time region, as shown at step 220.

For example, referring to FIGS. 1 and 4, the processor 112 can signal the display driver 136 to cause an analog clock face 300 to be displayed on the display 134. This analog clock face 300 can represent an image of a traditional analog clock, although the analog clock face 300 can incorporate any other suitable design. This analog clock face 300 can be used to indicate to a user of the electronic device 110 the current time. In accordance with an embodiment of the inventive arrangements, the analog clock face 300 can—also be used to indicate to the user when scheduled appointments are due to occur and their duration.

In one arrangement, a series of numbers 310 can be positioned along an edge 312 of the analog clock face 300. To provide the current time, the analog clock face 300 can include a minute hand 314 and an hour hand 316, which can correspond to the configuration of conventional analog clocks. As an example, the analog clock face 300 of FIG. 4 reflects a time of roughly 2:00 pm. A feature for distinguishing when the current time is in PM or AM will be explained below.

In one arrangement, the analog clock face 300 can be divisible into a plurality of time regions 318. A time region 318 can be any suitable amount or block of time, such as a one-half hour or one hour block of time. As an example, these time regions 318 can be used to designate when an appointment is scheduled as well as its duration. Although the time regions 318 to be discussed here are shown as minute regions (e.g., one-half four) and hour regions (one hour), it is understood that the time regions 318 can include other suitable time blocks, including second blocks or day-long or week-long blocks.

In one particular arrangement, the time regions 318 can include at least a portion of an AM section 320 and a PM section 322. The AM section 320 and the PM section 322 can give an indication as to which part of the day an appointment is scheduled, such as in the morning or at night. Although the AM section 320 and the PM section 322 are shown as a pair of concentric circles, it is understood that many other suitable methods to indicate to a user of the electronic device 110 which part of the day an appointment occurs can be implemented into the analog clock face 300.

Several examples of displaying appointments will now be presented. If a user has an appointment that is scheduled to start at 4:00 pm on a particular day and to end one hour later at 5:00 pm, the user can enter this information into the electronic device 110. Specifically, the user can enter appointment information into the electronic device 110 through any suitable component of the user interface section 116, such as the keypad 130, the display 134 and the microphone 142. Appointment information can include the start time, the duration (or end time), the location and any participants. For further appointment information, the user can select from any suitable menu a short description of the appointment and/or an icon that represents the general nature of the appointment. Additionally, the appointment information can be received from another electronic device, such as a desktop computer. As mentioned earlier, this appointment information can be received at the synchronization section 118.

Of course, the invention is not limited to these examples, as other types of information or data can be considered appointment information and any other suitable way to enter the information can be performed. For purposes of the invention, the term appointment can include any scheduled meeting or conference or any reminder for an individual. Without limitation, suitable examples include medical or dental appointments, office meetings, scheduled automobile maintenance or social events.

Once this information is entered into the electronic device 110, the processor 112 can transfer the information to be stored in the memory block 120. In one arrangement, on the day that an appointment is scheduled to be held, for example, the processor 120—using the appointment application 121—can associate a time region 318 with the appointment. The processor 112 can then instruct the display driver 136 to cause the time region 318 associated with the appointment to be displayed. Depending on the time of day for which the appointment is scheduled, the AM section 320 or the PM section 322 can also be displayed. For example, for the appointment scheduled from 4:00 to 5:00 pm, a time region 318, including a portion of the PM section 322, can be displayed in which the time region 318 corresponds to the appropriate numbers 310 on the analog clock face 300. In this manner, the user can determine that the appointment is scheduled to occur from 4:00 pm to 5:00 pm, instead of from 4:00 am to 5:00 am.

As shown in FIG. 4, another exemplary appointment can be scheduled from 7:00 pm to 7:30 pm, with the appropriate time region 318 and portion of the PM section 322 being displayed. Yet another exemplary appointment can be scheduled from 8:00 am to 9:00 am. As the user is aware of the current time, 2:00 pm in this case, the user can realize that the appointment is scheduled for the next morning.

If the user has selected an icon and/or a description, the processor 112 can assign the icon or the description to the relevant time region 318, each of which can indicate the type of appointment associated with the time region 318. As an example, the appointment scheduled from 4:00 to 5:00 pm can be a dental appointment, and an icon 324 representing a tooth can be displayed in the appropriate time region 318 or at any other suitable location of the display 134. Additionally, a short description 326 of the appointment can be displayed in a description block 328 or any other suitable location of the display 134. Those of skill in the art will appreciate that the icon 324 and the short description 326 can take any form that suitably corresponds to the type of appointment scheduled for the relevant time region 318. In addition, other forms of identifying the type of appointment for a particular time region 318, other than icons or short descriptions, can be employed in the invention. Additional steps concerning the display of the description 326 will be presented later.

Referring back to the method 200 of FIG. 2, at step 222, the time region, including at least the portion of the AM section and the PM section, can be marked to indicate visually that the appointment is associated with the time region. As an example, at option step 224, the time region can be bounded with at least a first segment and a second segment. The first segment can border the temporal beginning of the time region, and the second segment can border the temporal end of the time region. Continuing with the example, referring to FIG. 3, at option step 226 (through jump circle A), at least a portion of the time region between the first segment and the second segment can be shaded. This shaded portion of the time region can include at least a portion of the AM section and the PM section.

For example, referring back to FIGS. 1 and 4, the time regions 318 can be bounded with a first segment 330 and a second segment 332. The first segment 330 can indicate when the appointment associated with the time region 318 is scheduled to begin. The second segment 332 can indicate when the appointment is scheduled to end. In addition, the portion of the time region 318 in between the first segment 330 and the second segment 332, including at least a portion of the AM section 320 or the PM section 322, can be shaded. This portion of the time region 318 can be referred to as a shaded portion 334.

There are various ways to shade the time region 318, including for both color and monochrome displays. For example, the appointment associated with the time region 318 that runs from 4:00 pm to 5:00 pm can be shaded with diagonal lines or any other suitable pattern. If the display 134 is a color display, then the first segment 330, the second segment 332 and the shading portion 334—in this case, the diagonal lines—can all be of the same color, for example.

This shading process can help a user quickly locate scheduled appointments on the analog clock face 300. Although the portion of the time region 318 that is bounded and shaded (i.e., marked) is equal to the relevant AM section 320 or PM section 322, as shown in FIG. 4, it is understood that the area of the time region 318 may extend beyond the relevant AM section 320 or PM section 322. This extended portion of the time region 318 may also be marked in accordance with the inventive arrangements.

It is understood that the invention is in no way limited to the shading example described above, as any other suitable process can be employed to mark the time regions 318 and the AM sections 320 and PM sections 322. In fact, the step of shading is completely optional and can be skipped altogether. For purposes of the invention, the term marking can mean any step, process or act that enables a user to distinguish a particular time region 318 from any other time region 318 or any other portion of the analog clock face 300 or any other portion of the display 134. The term shading can mean any process used to emphasize or accentuate the area of the time region 318 between the first segment 330 and the second segment 332.

Referring back to FIG. 3, at step 228, a subsequent time region can be associated with a subsequent appointment. At step 230, the subsequent time region, including at least a portion of the AM section or the PM section, can be marked to indicate visually that the subsequent appointment is associated with the subsequent time region. In one arrangement, the first segment, the second segment and the shaded portion of the subsequent time region can all be comprised of a color that is different from the color of the first segment, the second segment and the shaded portion of any other time regions.

Once again referring to FIGS. 1 and 4, a user may enter information about another, i.e., subsequent, appointment into the electronic device 110. A subsequent appointment can be the most recent appointment entered into the electronic device 110. As an example, in accordance with the above description, a time region 318, including a portion of the PM section 322, can be generated and displayed in accordance with the above description in which the time region 318 corresponds to the time period from 7:00 pm to 7:30 pm. The color for the first segment 330, the second segment 332 and the shaded portion 334 of this time period 318 can have a color that is different from the first segment 330, the second segment 332 and the shaded portion 334 of any other time region 318.

In addition, any pattern that is used to complete the shaded portion 334 of the subsequent time region 318 can be different from any other time region 318. Examples are shown in FIG. 4 in which the shaded portion 334 of the time regions 318 from 4:00 pm to 5:00 pm, from 7:00 pm to 7:30 pm and from 8:00 am to 9:00 am each have different patterns. The above processes, while optional, can help a user better distinguish between different appointments that are reflected on the analog clock face 300.

As noted earlier, a description 326 of an appointment can be displayed on the display 134. Certain criteria can be considered in deciding when to display a description 326. Referring back to FIG. 3, at decision block 232, it can be determined whether the time region is an upcoming region. If it is not, the method 200 can resume at step 236. If it is, at step 234, the description of the time region can be displayed.

For example, referring to FIGS. 1 and 4 again, in this example, the current time as displayed on the analog clock face 300 is about 2:00 pm. The appointment that is the next scheduled appointment is the dental appointment that is associated with the time region 318 that runs from 4:00 pm to 5:00 pm. This time region 318 can be referred to as an upcoming time region, or a time region 318 that is the next scheduled time region 318 based on the current time displayed by the analog clock face 300. As such, the description 326 that is assigned to the upcoming time region 318 can be displayed in the description block 328 or any other suitable location of the display 134.

Once the current time passes the upcoming time region 318, the next time region 318 can be designated as the upcoming time region 318. Thus, the description 326 for the new upcoming time region 318 can be displayed in the description block 328. For example, if the current time, as shown on the analog clock face 300, moves past 5:00 pm, the time region 318 that runs from 7:00 pm to 7:30 pm can be considered the upcoming time region 318. The description 326 relating to this appointment can be displayed in the description block 328. Of course, the invention is not so limited, as the description 326 or any other suitable information associated with any suitable number of time regions 318 can be displayed at other suitable times and locations on the display.

Referring back to FIG. 3, at step 236, the time region that is associated with the appointment can be selected to access the information that is associated with the appointment. At step 238, either the AM section or the PM section can be shifted towards the numbers, and this shift can be based on the current time. Moreover, once the time region expires, the time region can be demarked. Finally, the method 200 can end at step 242.

For example, referring back to FIGS. 1 and 4, the user can select any one of the time regions 318 to obtain information concerning the appointment that is associated with the selected time region 318. Those of skill in the art will appreciate that any suitable method can be used to allow a user to select the desired time region 318. Suitable examples include pressing one or more keys on the keypad 130, touching the position on the display 134 where the time region 318 sits or using some other suitable user interface. Once selected, the processor 112 can cause any information associated with the appointment to be displayed on the display 134, such as the location, the participants, the subject matter, etc. In another arrangement, all or a portion of this information can be continuously displayed on the display 134, if so desired, which can eliminate the need to access the information.

As mentioned above, the AM section or the PM section can be shifted based on the current time. For example, if the current time, as reflected on the analog clock face 300, is at or after noon but before midnight, the PM section 322 can be positioned on the outside of the AM section 320. That is, the PM section 322 can be positioned closer to the numbers 310 on the edge 312 of the analog clock face 300, a scenario that is pictured in FIG. 4. When the current time reaches or moves past midnight, the processor 112 can signal the display driver 136 to cause the AM section 320 and the PM section 322 to be shifted on the display 134 such that the AM section 320 is positioned outside the PM section 322. As a result, the AM section 320, during the time from midnight until noon, can be positioned closer to the numbers 310. When the current time reaches midnight again, the processor 112 can cause the PM section 322 and the AM section 320 to once again be shifted such that the PM section 322 is outside the AM section 320 on the display 134.

This process can keep the marked time sections 318 closer to the numbers 310 during the twelve hour shift when the appointment is supposed to occur. Thus, a user can better determine when an appointment is supposed to begin and end. Also, the shifting feature can permit a user to ascertain in which part of the day, AM or PM, the current time is situated. This step may be useful to a user who is groggy or in a building that keeps the user out of contact with the outside environment.

As also noted above, once a time region 318 expires, that time region 318 can be demarked. For example, once the current time moves past the scheduled end time of an appointment that is associated with a particular time region 318, the processor 112 can cause the marking that was added to the time region 318 to be removed by signaling the display driver 136. That is, any combination of the first segment 330, the second segment 332 or the shaded portion 334 can be removed from the display 134. Alternatively, the processor 112 can cause the color of the first segment 330, the second segment 332 or the shaded portion 334 to be changed. As another example, the processor 112 can cause a symbol to be displayed over or near the time region 318, such as an “X,” to indicate that the appointment has expired. In fact, the term demarking can mean any process taken to indicate to a user that the time region 318 has expired, i.e., that the scheduled time for the appointment has passed.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for displaying appointments, comprising the steps of:
in an electronic device, displaying an analog clock face that is divisible into a plurality of time regions, wherein the plurality of time regions includes at least a portion of an ante meridiem section and a post meridiem section;
associating a time region with an appointment; and
marking the time region, including at least the portion of one of the ante meridiem section and the post meridiem section, to indicate visually that the appointment is associated with the time region.

2. The method according to claim 1, further comprising the step of assigning an icon to the time region to indicate the type of appointment associated with the time region.

3. The method according to claim 1, wherein the marking the time region step comprises the steps of:
bounding the time region with at least a first segment and a second segment, wherein the first segment borders the temporal beginning of the time region and the second segment borders the temporal end of the time region; and
shading at least a portion of the time region between the first segment and the second segment, wherein the shaded portion of the time region includes the portion of at least one of the ante meridiem section and the post meridiem section.

4. The method according to claim 3, wherein the first segment, the second segment and the shaded portion are all comprised of the same color.

5. The method according to claim 4, further comprising the steps of:
associating a subsequent time region with a subsequent appointment; and
marking the subsequent time region, including at least the portion of one of the ante meridiem section and the post meridiem section, to indicate visually that the subsequent appointment is associated with the subsequent time region, wherein the first segment, the second segment and the shaded portion of the subsequent time region are all comprised of a color that is different from the color of the first segment, the second segment and the shaded portion of any other time regions.

6. The method according to claim 1, wherein the time regions are selected from the group comprising minute regions and hour regions.

7. The method according to claim 1, further comprising the step of demarking the time region once the time region expires.

8. The method according to claim 1, further comprising the steps of:
entering information associated with the appointment into the electronic device; and
selecting the time region that is associated with the appointment to access the information associated with the appointment.

9. The method according to claim 1, wherein the analog clock face has a series of numbers that are positioned along an edge of the analog clock face, and the method further comprises the step of shifting towards the numbers at least one of the ante meridiem section and the post meridiem section based on the current time.

10. The method according to claim 1, further comprising the steps of:
assigning a description to the time region;
determining whether the time region is an upcoming time region; and
displaying the description of the time region if the time region is an upcoming region.

11. A system for displaying appointments, comprising:
a user interface section having at least a display for displaying an analog clock face that is divisible into a plurality of time regions, wherein the plurality of time regions includes at least a portion of an ante meridiem section and a post meridiem section; and
a processor coupled to the user interface section, wherein the processor is programmed to:
associate a time region with an appointment; and
mark the time region, including at least the portion of one of the ante meridiem section and the post meridiem section, to indicate visually that the appointment is associated with the time region.

12. The system according to claim 11, wherein the processor is further programmed to assign an icon to the time region to indicate the type of appointment associated with the time region.

13. The system according to claim 11, wherein the processor is further programmed to mark the time region by:
bounding the time region with at least a first segment and a second segment, wherein the first segment borders the temporal beginning of the time region and the second segment borders the temporal end of the time region; and
shading at least a portion of the time region between the first segment and the second segment, wherein the shaded portion of the time region includes the portion of at least one of the ante meridiem section and the post meridiem section.

14. The system according to claim 13, wherein the first segment, the second segment and the shaded portion are all comprised of the same color.

15. The system according to claim 14, wherein the processor is further programmed to:
associate a subsequent time region with a subsequent appointment; and
mark the subsequent time region, including the portion of at least one of the ante meridiem section and the post meridiem section, to indicate visually that the subsequent appointment is associated with the subsequent time region, wherein the first segment, the second segment and the shaded portion of the subsequent time region are all comprised of a color that is different from the color of the first segment, the second segment and the shaded portion of any other time regions.

16. The system according to claim 11, wherein the time regions are selected from the group comprising minute regions and hour regions.

17. The system according to claim 11, wherein the processor is further programmed to demark the time region once the time region expires.

18. The system according to claim 11, wherein the user interface section receives information associated with the appointment and permits a user to select the time region that is associated with the appointment to access the information associated with the appointment.

19. The system according to claim 11, wherein the analog clock face has a series of numbers that are positioned along an edge of the analog clock face and the processor is further programmed to shift towards the numbers at least one of the ante meridiem section and the post meridiem section based on the current time.

20. The system according to claim 11, wherein the processor is further programmed to:
assign a description to the time region;
determine whether the time region is an upcoming time region; and
cause the display to display the description of the time region if the time region is an upcoming region.

21. A machine readable storage, having stored thereon a computer program having a plurality of code sections executable by a computing device for causing the computing device to perform the steps of:
displaying an analog clock face that is divisible into a plurality of time regions, wherein the plurality of time regions includes at least a portion of an ante meridiem section and a post meridiem section;
associating a time region with an appointment; and
marking the time region, including at least the portion of one of the ante meridiem section and the post meridiem section, to indicate visually that the appointment is associated with the time region.

22. The machine readable storage according to claim 21, wherein the code sections further cause the computing device to perform the step of assigning an icon to the time region to indicate the type of appointment associated with the time region.

23. The machine readable storage according to claim 21, wherein the code sections further cause the computing device to perform the marking the time region step by:
bounding the time region with at least a first segment and a second segment, wherein the first segment borders the temporal beginning of the time region and the second segment borders the temporal end of the time region; and
shading at least a portion of the time region between the first segment and the second segment, wherein the shaded portion of the time region includes the portion of at least one of the ante meridiem section and the post meridiem section.

24. The machine readable storage according to claim 23, wherein the first segment, the second segment and the shaded portion of the time region are all comprised of the same color;
wherein the code sections further cause the computing device to perform the steps of:
associating a subsequent time region with a subsequent appointment; and
marking the subsequent time region, including the portion of at least one of the ante meridiem section and the post meridiem section, to indicate visually that the subsequent appointment is associated with the subsequent time region, wherein the first segment, the second segment and the shaded portion of the subsequent time region are all comprised of a color that is different from the color of the first segment, the second segment and the shaded portion of any other time regions.

25. The machine readable storage according to claim 21, wherein the code sections further cause the computing device to perform the step of demarking the time region once the time region expires.

26. The machine readable storage according to claim 21, wherein the code sections further cause the computing device to perform the steps of:
receiving information associated with the appointment; and
permitting a user to select the time region that is associated with the appointment to access the information associated with the appointment.

27. The machine readable storage according to claim 21, wherein the analog clock face has a series of numbers that are positioned along an edge of the analog clock face, and wherein the code sections further cause the computing device to perform the step of shifting towards the numbers at least one of the ante meridiem section and the post meridiem section based on the current time.

28. The machine readable storage according to claim 21, wherein the code sections further cause the computing device to perform the steps of:
assigning a description to the time region;
determining whether the time region is an upcoming time region; and
displaying the description of the time region if the time region is an upcoming region.
